(19) United States
(12) Patent Application Publication
(10) Pub. No.: US 2007/0132814 A1
(43) Pub. Date: Jun. 14, 2007

(54) Ink filling mechanism for ink-jet cartridge

(75) Inventors: Charles C. Chang, Hsinchu City (TW); Wen-Chung Yen, Hsinchu City (TW)

Correspondence Address: BRUCE H. TROXELL, SUITE 1404, 5205 LEESBURG PIKE, FALLS CHURCH, VA, 22041, US

(73) Assignee: JUST-PRINT TECHOLOGY CO., LTD.

(21) Appl. No.: 11/442,591

(22) Filed: May 30, 2006

(30) Foreign Application Priority Data
May 31, 2005 (TW) 94117741

(51) Int. Cl. B41J 2/17

(52) U.S. Cl. 347/84

(57) ABSTRACT

An ink filling mechanism is used to hold an ink-jet cartridge thereto for easily and effectively refilling the ink cartridge. The ink filling mechanism has an ink cartridge holder, which includes a holding case provided at a top wall with at least one ink filling opening for locating an ink injecting device to an adequate position for injecting ink into the ink cartridge. The ink cartridge holder of the ink filling mechanism also includes an ink nozzle sealing pad and an ink-pumping sealing pad, which may be selectively positioned at a bottom of the holding case to facilitate the injecting of ink into or the pumping of ink from the ink cartridge being refilled.

### FIELD OF THE INVENTION

The present invention relates to an ink filling mechanism for an ink cartridge used on an ink-jet printing platform, and more particularly to an ink filling mechanism that firmly holds an ink cartridge to be refilled and allows an ink injecting device to be accurately positioned to effectively refill the ink cartridge.

### BACKGROUND OF THE INVENTION

In an ink-jet printer, at least one ink cartridge is provided. Some of the ink cartridges are integrally associated with an ink jet controlling print head, while others are separable from the print head. In either case, most of the empty ink cartridges are reusable. Discarding of these reusable ink cartridges is apparently wrong from the view point of environment protection. Therefore, there are suggestions of refilling these empty ink cartridges for use again. FIG. 1A shows a conventional ink cartridge holder 10 for refilling an empty ink cartridge, and FIG. 1B shows ink is filled into an empty ink cartridge 14 held in place by the holder 10. As shown in FIG. 1A, the ink cartridge holder 10 includes a holding seat 11 and an ink-pumping sealing pad 12. The empty ink cartridge 14 is upright held in the holding seat 11 for easy ink filling and ink pumping. The holding seat 11 is provided at an upper end with an elastic fastener 13 for firmly holding the ink cartridge 14 to the holder 10, so that ink may be filled into the ink cartridge 14 using an ink injecting device 16. The ink cartridge 14 shown in FIG. 1B is a three-color ink cartridge having three ink filling holes 15a, 15b, and 15c. Ink of different colors must be sequentially filled into the ink cartridge 14 via the three ink filling holes 15a, 15b, and 15c separately. When the ink is filled into the empty ink cartridge 14 held in the conventional ink cartridge holder 10, it is very possible the ink could not flow to the pint head smoothly. To overcome this problem, an ink-pumping sealing pad 12 is normally provided on the conventional ink cartridge holder 10 to seal areas around an ink nozzle area of the ink cartridge 14, so that an ink pumping syringe 17 may be used to pump ink. FIG. 1C shows the use of the conventional ink cartridge holder 10 to pump ink from the ink cartridge 14.

While the above-described conventional ink cartridge holder 10 provides the function of assisting in refilling an empty ink cartridge 14, it does not allow a user to easily control a depth by which the ink injecting device 16 should be inserted into the ink filling holes 15a, 15b, and 15c. It is known a proper ink injection position has great influence on the quality of the ink cartridge. It is impossible for a user to determine without any aid whether the ink injecting device 16 has been inserted to a proper depth for injecting ink into the ink cartridge 14. When the ink injecting device 16 is fully inserted, it could seal the ink filling hole 15a, 15b, or 15c, and therefore an amount of ink the same as those being filled into the ink cartridge 14 would be forced out of the ink cartridge 14 at the same time.

Moreover, some of the ink cartridges have ink filling holes being covered with a label, removal of which is troublesome and effort-consuming, and would result in an ugly and excessively large opening on the ink cartridge that causes quick drying of ink. Some refill kit manufacturers try to provide a mark label in an attempt to assist user in locating the ink injecting device on the ink cartridge. The ink injecting device 16 can be easily aligned with a position indicated by the mark label and then inserted into the ink cartridge 14. To do this, the user has to carefully attach the mark label to the ink cartridge 14. The attached mark label together with the original label on the ink filling holes 15a, 15b, 15c of the ink cartridge 14 produce an increased thickness that is not easily pierced through by the ink injecting device 16.

The ink-pumping sealing pad 12 provided on the conventional ink cartridge holder 10 seals only the areas around the ink nozzle area of the ink cartridge 14. It is still possible that ink filled into the ink cartridge 14 is forced out of the ink nozzle and flows to the surface of the ink nozzle plate, resulting in a smudged ink nozzle and mixing of ink colors, particularly in the case of a color ink cartridge.

### SUMMARY OF THE INVENTION

A primary object of the present invention is to provide an ink filling mechanism for ink-jet cartridge. The ink filling mechanism includes an ink cartridge holder for holding an ink cartridge in place for refilling. The ink cartridge includes at least one ink aperture. The ink cartridge holder includes a holding case having a top wall, on which at least one ink filling opening is provided corresponding to the ink aperture on the ink cartridge. The ink filling opening assists in the 3D (three-dimensional) positioning of an ink injecting device inserted into the ink cartridge via the ink filling opening and the ink aperture. That is, when the ink injecting device is fully inserted into the ink filling opening, it is restricted not only to a fixed point on a planar surface but also to a predetermined depth into the ink cartridge for injecting ink. To prevent the ink injecting device from sealing the ink aperture, either a small vertical distance is provided between the ink aperture and the top wall of the holding case, or the ink filling opening has a size and shape different from that of an injecting head of the ink injecting device to ensure a non-airtight contact of the ink filling opening with the ink injecting device.

The ink cartridge holder of the present invention may further include an ink nozzle sealing pad, an area of which aligned with the ink nozzle area of the ink cartridge is a planar surface. The ink nozzle sealing pad with a planar surface together with an elastic fastener provided on a top of the holding case seal the ink nozzle of the ink cartridge held in the holding case, so as to avoid the problem of mixed color ink.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a perspective view of a conventional ink cartridge holder for an ink-jet cartridge;

FIG. 1B is a perspective view showing the use of the conventional ink cartridge holder of FIG. 1A to refill an ink-jet cartridge;

FIG. 1C is a front view showing the use of the conventional ink cartridge holder of FIG. 1A to pump ink from an ink-jet cartridge;

FIG. 2A is a perspective view of an ink cartridge holder included in an ink filling mechanism for ink-jet cartridge according to a first embodiment of the present invention;

FIG. 2B shows a nozzle sealing pad included in the present invention;

FIG. 2C shows the ink cartridge holder of FIG. 2A with the nozzle sealing pad of FIG. 2B assembled thereto;

FIG. 2D shows the manner of associating an ink-jet cartridge with the ink cartridge holder of FIG. 2A;

FIG. 2E shows the manner of filling ink into the ink-jet cartridge held in the ink cartridge holder of FIG. 2A;

FIGS. 3A and 3B are perspective views showing an ink cartridge holder included in an ink filling mechanism for ink-jet cartridge according to a second embodiment of the present invention;

FIG. 4A is a perspective view of an ink cartridge holder included in an ink filling mechanism for ink-jet cartridge according to a third embodiment of the present invention;

FIG. 4B is a perspective view of an ink cartridge holder included in an ink filling mechanism for ink-jet cartridge according to a fourth embodiment of the present invention; and

FIG. 5 shows an ink-pumping sealing pad included in the present invention.

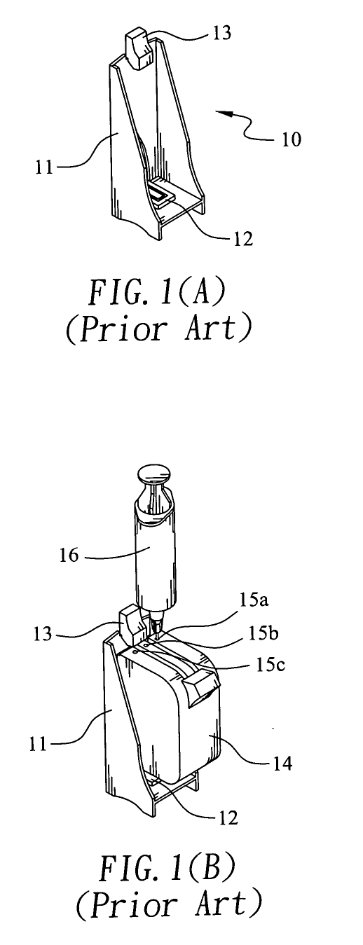

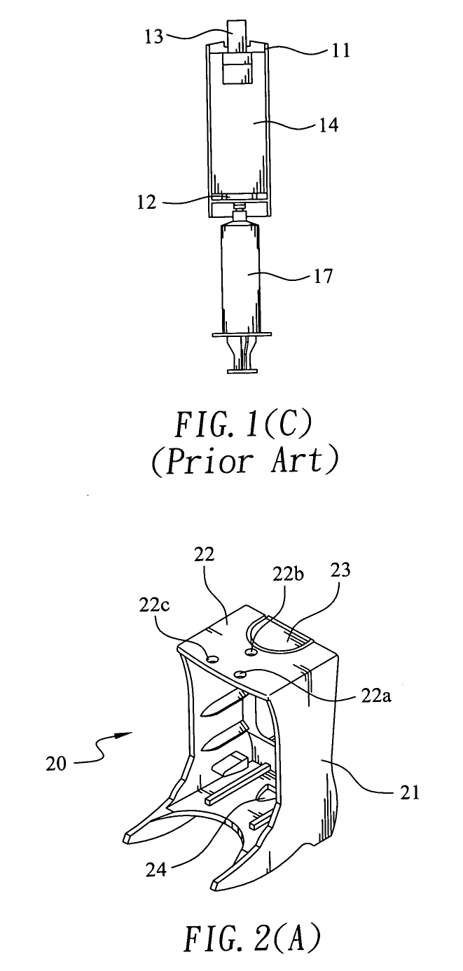

### DETAILED DESCRIPTION OF THE PREFERRED EMBODIMENTS

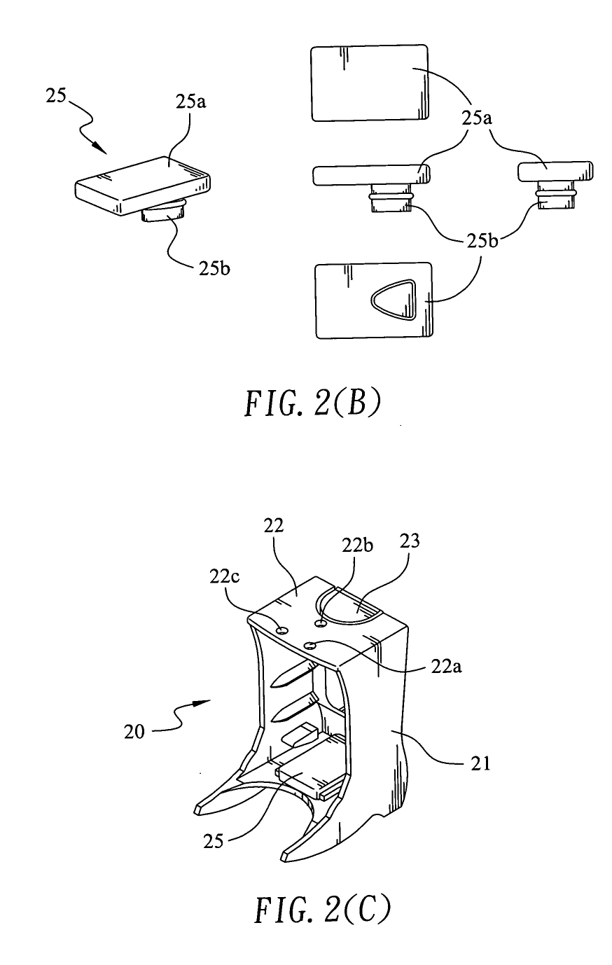

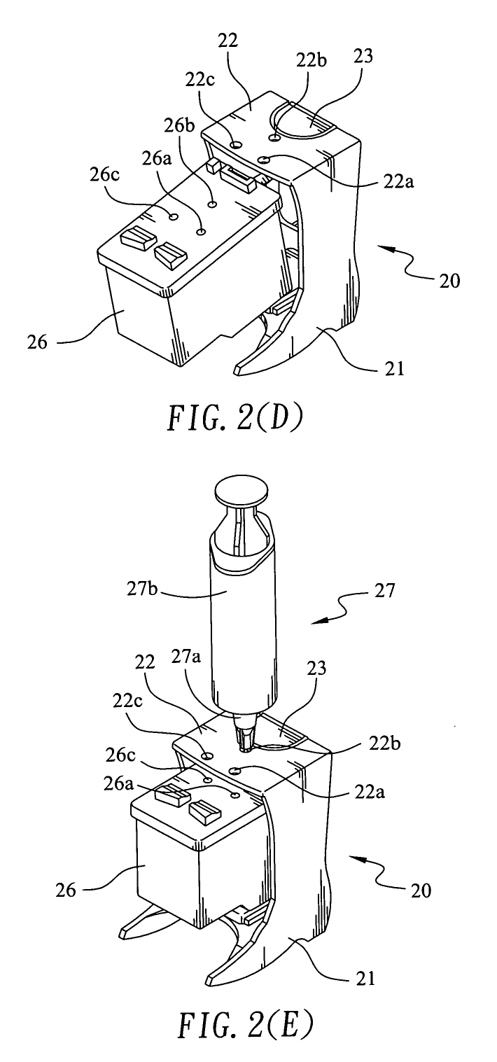

Please refer to FIG. 2A that is a perspective view of an ink cartridge holder 20 included in an ink filling mechanism for ink-jet cartridge according to a first embodiment of the present invention. In the illustrated preferred embodiment, the ink cartridge holder 20 is designed for holding a tri-color ink cartridge 26 to be refilled (see FIGS. 2D and 2E) . The ink cartridge holder 20 is an integrally formed member including a holding seat 21 and a top wall 22 located at a top of the holding seat 21. The top wall 22 is a flat plate provided with three openings 22a, 22b, and 22c, via which an ink injecting device 27 (see FIG. 2E) may be inserted to achieve three-dimensional (3D) positioning. In the case of a mono ink cartridge, only one ink filling opening is required. The ink filling openings 22a, 22b, and 22c may be in the form of a hole or a slit.

Please refer to FIGS. 2B and 2C. The ink filling mechanism for ink-jet cartridge according to the first embodiment of the present invention may further includes an ink nozzle sealing pad 25 for sealing an ink nozzle area on the ink cartridge 26 to be refilled, so as to prevent the refilled ink from flowing out of the ink cartridge 26 via the ink nozzle area to smudge or cause mixing of color ink at the ink nozzle area. As shown in FIG. 2B, an area of the ink nozzle sealing pad 25 in contact with the ink nozzle area on the ink cartridge 26 is a planar structure 25a. As to other areas of the ink nozzle sealing pad 25 that are not in contact with the ink nozzle area may be flush with or slightly lower than the area in contact with the ink nozzle area. When a sufficient contact force exists between the nozzle contacting area 25a and the ink nozzle area of the ink cartridge 26, the ink nozzle area is sealed. A locating member 25b is provided below the ink nozzle sealing pad 25. FIG. 2C shows the ink cartridge holder 20 with the ink nozzle sealing pad 25 assembled to a bottom of the holding seat 21. The ink nozzle sealing pad 25 is assembled to the bottom of the holding seat 21 by engaging the locating member 25b with a locating hole 24 (see FIG. 2A) formed on the holding seat 21. The ink nozzle sealing pad 25 assembled to the holding seat 21 is located at a position corresponding to the ink nozzle area of the ink cartridge 26.

Please refer to FIGS. 2D and 2E. The ink cartridge 26 to be refilled is aligned with and plugged in the ink cartridge holder 20 at a predetermined inclination, and then horizontally pushed forward until the ink cartridge 26 is engaged with and held in place by an elastic fastener 23 provided at the top wall 22 of the ink cartridge holder 20. When the ink cartridge 26 is correctly located in the holding seat 21, the three filling openings 22a, 22b, and 22c on the top wall 22 are separately aligned with three ink apertures 26a, 26b, and 26c on the ink cartridge 26, allowing the ink injecting device 27 to be accurately inserted into a desired one of the ink apertures 26a, 26b, or 26c via a corresponding ink filling hole 22a, 22b, or 22c, without being affected by any label covering the ink aperture 26a, 26b, and 26c. With an upper end held in place by the elastic fastener 23 on the top wall 22 of the ink cartridge holder 20, and a lower end contacting with the ink nozzle sealing pad 25 to seal the ink nozzle area, the ink cartridge 26 is firmly held in the ink cartridge holder 20. Therefore, it can be determined that the ink injecting device 27 has reached a correct position in the ink cartridge 26 for injecting ink when the ink injecting device 27 was fully inserted into the ink cartridge holder 20 via the ink filling openings 22a, 22b or 22c. The correct position for injecting ink is preferably a position in the ink cartridge 26 at where residual ink exists to contact with the ink nozzle area, so as to prevent forming of any bubbles between the residual ink and the refilled ink. The bubbles formed between the residual ink and the refilled ink would flow to and clog ink passages of the ink cartridge 26. Preferably, the correct position for injecting ink is within 20 mm distant from a filter in the ink cartridge 26. More preferably, the correct position for injecting ink is within 10 mm distant from the filter in the ink cartridge 26.

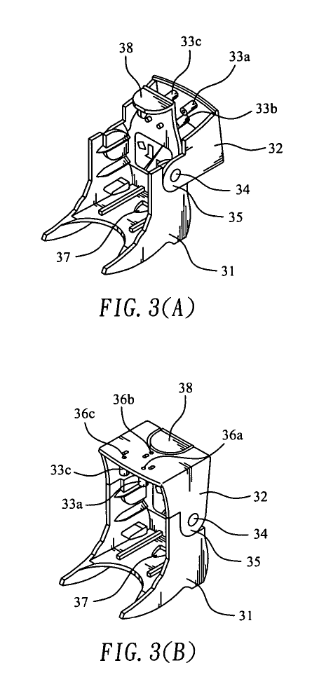

FIG. 3A shows an ink cartridge holder included in an ink filling mechanism for ink-jet cartridge according to a second embodiment of the present invention. As shown, the ink cartridge holder in the second embodiment includes a holding seat 31 and a top cover 32. The top cover 32 defines the top wall of the ink cartridge holder, and is pivotally connected to a top of the holding seat 31 through engagement of two ring portions 35 of the top cover 32 with two pins 34 on the holding seat 31. However, it is understood the top cover 32 may also be pivotally connected to the top of the holding seat 31 by any other known manners. For example, the ring portions 35 may define two semi-circular rings instead of two complete rings; and the two pins 34 are not necessarily integrally formed on the holding seat 31, but may be replaced with a crossbar extended across the holding seat 31. Moreover, the top cover 32 is provided with three hollow ink guiding bars 33a, 33b, and 33c downward extended from the top cover 32 into the holding seat 31, so as to further guide the ink injecting device to a correct insertion direction. Every one of the hollow ink guiding bars 33a, 33b, and 33c corresponds to an ink filling opening 36a 36b 36c provided on the top cover 32. It is noted the ink hollow guiding bars 33a, 33b, and 33c are not necessarily perpendicularly to the top cover 32, but may be inclined by different angles, depending on the type of ink cartridge to be refilled and the actual requirements in refilling the ink cartridge. Moreover, each of the hollow ink guiding bars 33a, 33b, and 33c defines a guiding channel, which preferably has a downward tapered bore. A locating hole 37 similar to the locating hole 24 in FIG. 2A is provided on a bottom of the holding seat 31 for an ink nozzle sealing pad to engage therewith. An ink cartridge to be refilled is plugged in the holding seat 31 and horizontally pushed forward until the ink cartridge is held in place by an elastic fastener 38 provided on a top of the holding seat 31. FIG. 3B shows the ink cartridge holder of the second embodiment with the top cover 32 closed onto the top of the holding seat 31. At this point, ink may be filled into a located ink cartridge (not shown) via the ink filling openings 36a, 36b, 36c and the hollow ink guiding bars 33a, 33b, and 33c using an ink injecting device (not shown).

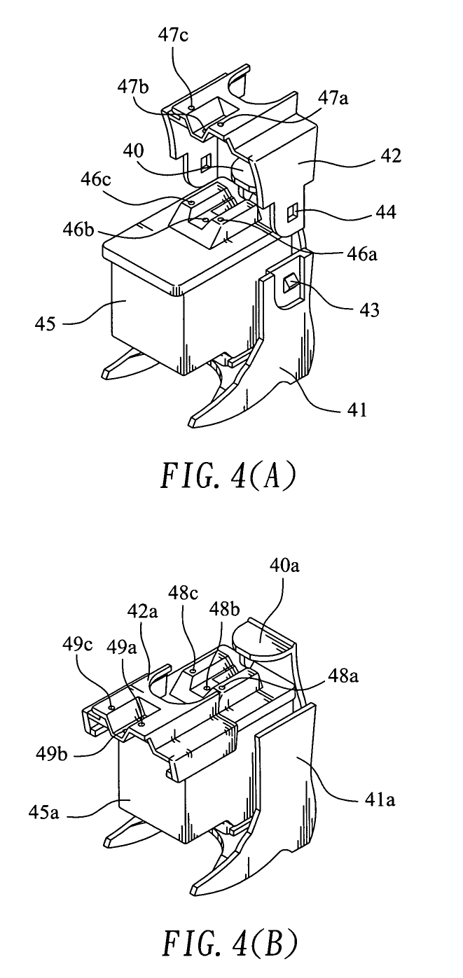

FIG. 4A shows an ink cartridge holder included in an ink filling mechanism for ink-jet cartridge according to a third embodiment of the present invention. As shown, the ink cartridge holder in the third embodiment includes a holding seat 41 and a top cover 42. The top cover 42 defines a top wall of the ink cartridge holder, and is detachably connected to a top of the holding seat 41 just before the ink refilling to provide a correct position for locating an ink injecting device. The holding seat 41 is provided with a reference point (as lugs 43 in FIG. 4A) , which assists in correct positioning of the top cover 42 on the holding seat 41. The top cover 42 is detachably connected to the holding seat 41 through engagement of engaging holes 44 on the top cover 42 with lugs 43 correspondingly formed on the holding seat 41. At this point, ink filling openings 47a, 47b, and 47c provided on the top cover 42 are separately aligned with ink apertures 46a, 46b, and 46c on an ink cartridge 45 held in the holding seat 41 for refilling. Similarly, the ink cartridge 45 is held in place in the holding seat 41 by plugging the ink cartridge 45 into the holding seat 41 at a small angle, and then horizontally pushing the ink cartridge 45 forward until the ink cartridge 45 is engaged with an elastic fastener 40 provided at a top of the holding seat 41. It is understood the top cover 42 and the holding seat 41 are not necessarily connected together via the engaging holes 44 and the lugs 43, but may be connected via other means, such as two peripheral edges having configurations allowing engagement of the two edges and accordingly, the top cover 42 with the holding seat 41.

FIG. 4B shows an ink cartridge holder included in an ink filling mechanism for ink-jet cartridge according to a fourth embodiment of the present invention. As shown, the ink cartridge holder in the fourth embodiment includes a holding seat 41a and a top cover 42a. The top cover 42a defines a top wall of the ink cartridge holder, and is separated from the holding seat 41a and connected to a top of an ink cartridge 45a just before the ink refilling. Similarly, the ink cartridge 45a to be refilled is held in place in the holding seat 41a by plugging the ink cartridge 45a into the holding seat 41a at a small angle, and then horizontally pushing the ink cartridge 45a forward until the ink cartridge 45a is engaged with an elastic fastener 40a provided at a top of the holding seat 41a. The top cover 42a is connected to the ink cartridge 45a by sliding the top cover 42a along two flanges on the ink cartridge 45a until the top cover 42a reaches a predetermined position on the top of the ink cartridge 45a. At this point, ink filling openings 49a, 49b, and 49c provided on the top cover 42a are aligned with ink apertures 48a, 48b, and 48c provided on the ink cartridge 45a.

The top covers 42 and 42a do not necessarily have a planar top wall as in the first and second embodiments, but may be particularly shaped corresponding to the top of the ink cartridge 45, 45a at where the ink apertures are formed.

In all the illustrated embodiments of the present invention, the ink filling openings on the top wall or top covers of the ink cartridge holders are smaller than a diameter of an injecting head 27a of the ink injecting device 27 (see FIG. 2E) in all directions. The ink filling openings are most preferably smaller than the diameter of the injecting head 27a of the ink injecting device 27 or the size of the ink apertures on the ink cartridge to be refilled, so that it is always ensured the ink injected device may be correctly inserted into the ink cartridge even if the ink injecting device is not fully aligned with a center of the ink filling openings. Alternatively, the ink filling openings may be larger than the diameter of the injecting head 27a of the ink injecting device 27, but smaller than a diameter of an ink container 27b of the ink injecting device 27 (see FIG. 2E). Thereby when the diameter-expanded ink container 27b of the ink injecting device is stuck at the ink filling opening, it means the ink injecting device has been inserted to a proper depth. In the latter case, the ink injecting device must be inserted into the ink filling opening as close to the center of the ink filling opening as possible. In the event the ink apertures are clearly visible, the ink filling openings may also be a narrow slit, which is smaller than the injecting head 27a or the ink container 27b of the ink injecting device in only one direction. With the narrow slit, it is also possible to adequately limit the depth by which the ink injecting device is inserted into the ink filling openings.

As in the first embodiment, the second, third and fourth embodiments of the present invention may further include an ink nozzle sealing pad at a position corresponding to the ink nozzle area of the ink cartridge to be refilled, so as to avoid ink mixing and smudged ink nozzle area.

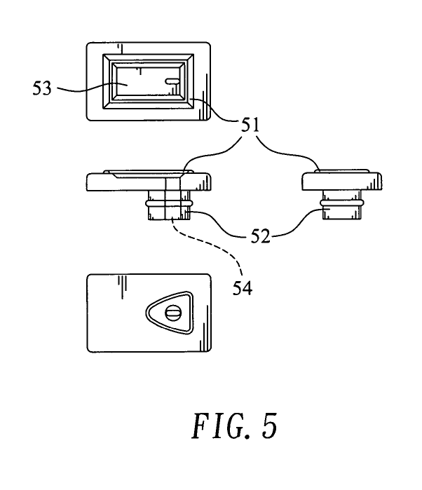

When an ink cartridge has not been used for a prolonged time or is improperly refilled, it is very possible the ink in the ink cartridge could not be smoothly supplied to the ink nozzle area. To overcome this problem, every one of the embodiments of the present invention may further include an ink-pumping sealing pad located in the holding seat corresponding to the ink nozzle area on the ink cartridge to be refilled. Please refer to FIG. 5. The ink-pumping sealing pad includes an open nozzle area 53 surrounded by a continuously extended elastic sealing strip 51, and a locating member 52 provided below the open nozzle area 53 to define an ink pumping passage 54 therein. An ink pumping tool may be connected to the ink pumping passage 54 for pumping ink. When a sufficient contact force exists between the ink cartridge and the ink-pumping sealing pad, the elastic sealing strip 51 around the open nozzle area 53 would seal a nozzle plate at the ink nozzle area of the ink cartridge. The elastic sealing strip 51 sealing the nozzle plate may be raised from or flush with a top of the ink-pumping sealing pad. The locating member 52 has a configuration the same as that of the locating member 25b of the ink nozzle sealing pad 25. Therefore, the locating hole provided at the bottom of the holding seat may be used to engage with any one of the ink nozzle sealing pad 25 and the ink-pumping sealing pad.

In the case the positioning of the ink injecting device is the only concern in refilling an ink cartridge, the ink cartridge holder may be simplified to a structure that only defines ink filling openings for the ink injecting device. This simplified structure may be clamped or attached to a predetermined position on the ink cartridge close to the ink apertures, such that the ink filling openings are aligned with the ink apertures for the ink injecting device to insert thereinto. The ink filling openings are smaller than the injecting head or the ink container of the ink injecting device in at least one direction, so as to limit the ink injecting device to a predetermined insertion depth and determine the position at where the ink is injected. Alternatively, as in the above-mentioned other embodiments, the ink filling openings on the ink cartridge holder having the simplified structure maybe smaller than the injecting head or the ink container of the ink injecting device in all directions, so that the ink injecting device can be easily inserted into the ink cartridge simply by aligning the injecting head with the ink filling openings. Again, it is most preferable the ink filling openings on the simplified ink cartridge holder are smaller than the sizes of the injecting head of the ink injecting device and the ink apertures on the ink cartridge. And, it is preferable the correct position for injecting ink is within 20 mm distant from the filter in the ink cartridge. More preferably, the correct position for injecting ink is within 10 mm distant from the filter in the ink cartridge.

What is claimed is:

1. An ink filling mechanism for ink-jet cartridge, comprising an ink cartridge holder, with which an ink cartridge is held in place for refilling; said ink cartridge holder including a holding case having a top wall, and said top wall being provided with at least one ink filling opening.

2. The ink filling mechanism for ink-jet cartridge as claimed in claim 1, wherein said holding case of said ink cartridge holder further includes an elastic fastener for firmly holding said ink cartridge to said holding case for refilling.

3. The ink filling mechanism for ink-jet cartridge as claimed in claim 1, wherein said ink cartridge includes at least one ink aperture, which is aligned with said at least one ink injecting opening on said top wall of said holding case when said ink cartridge is held in place by said ink cartridge holder.

4. The ink filling mechanism for ink-jet cartridge as claimed in claim 1, wherein said holding case of said ink cartridge holder includes a holding seat and a top cover; said top cover being pivotally connected to a top of said holding seat, so as to be upward turned open from said holding seat; and said top cover defining said top wall of said holding case.

5. The ink filling mechanism for ink-jet cartridge as claimed in claim 1, wherein said holding case of said ink cartridge holder includes a holding seat and a top cover; said top cover being fixedly connected to a top of said holding seat; and said top cover defining said top wall of said holding case.

6. The ink filling mechanism for ink-jet cartridge as claimed in claim 1, further comprising a hollow guiding bar downward extended from said at least one ink filling opening provided on the top wall;
and said hollowing guiding bar defining a guiding channel corresponding to said ink filling opening.

7. The ink filling mechanism for ink-jet cartridge as claimed in claim 6, wherein said guiding channel has a downward tapered bore.

8. The ink filling mechanism for ink-jet cartridge as claimed in claim 1, further comprising an ink injecting device; said ink injecting device including an injecting head and an ink container.

9. The ink filling mechanism for ink-jet cartridge as claimed in claim 8, wherein said ink injecting device is inserted into said ink aperture on said ink cartridge to reach an ink injecting position in said ink cartridge.

10. The ink filling mechanism for ink-jet cartridge as claimed in claim 9, wherein said ink injecting position is within 20 mm distant from a filter in said ink cartridge.

11. The ink filling mechanism for ink-jet cartridge as claimed in claim 9, wherein said ink injecting position is within 10 mm distant from a filter in said ink cartridge.

12. The ink filling mechanism for ink-jet cartridge as claimed in claim 9, wherein said ink injecting position is located in an area at where an amount of residual ink exists to contact with an ink nozzle of said ink cartridge.

13. The ink filling mechanism for ink-jet cartridge as claimed in claim 8, wherein said ink filling opening is smaller than a diameter of said injecting head or of said ink container of said ink injecting device in at least one direction.

14. The ink filling mechanism for ink-jet cartridge as claimed in claim 3, wherein said ink filling opening is smaller than a size of said ink aperture of said ink cartridge.

15. The ink filling mechanism for ink-jet cartridge as claimed in claim 1, wherein said ink filling opening is in the form of a hole.

16. The ink filling mechanism for ink-jet cartridge as claimed in claim 1, wherein said ink filling opening is in the form of a slit.

17. The ink filling mechanism for ink-jet cartridge as claimed in claim 1, wherein said ink cartridge holder further comprising an ink nozzle sealing pad being engaged with a locating hole provided on a bottom of said holding case.

18. The ink filling mechanism for ink-jet cartridge as claimed in claim 17, wherein said ink nozzle sealing pad is made of a material selected from the group consisting of a natural rubber material, a synthetic rubber material, and other elastomer materials.

19. The ink filling mechanism for ink-jet cartridge as claimed in claim 1, wherein said ink cartridge holder further comprising an ink-pumping sealing pad being engaged with a locating hole provided on a bottom of said holding case.

20. The ink filling mechanism for ink-jet cartridge as claimed in claim 19, wherein said ink-pumping sealing pad is made of a material selected from the group consisting of a natural rubber material, a synthetic rubber material, and other elastomer materials.
